(19) United States
(12) Patent Application Publication
(10) Pub. No.: US 2025/0359596 A1
(43) Pub. Date: Nov. 27, 2025

(54) A METHOD OF OPERATING AN AEROSOL PROVISION DEVICE

(71) Applicant: Nicoventures Trading Limited, London (GB)

(72) Inventors: Andrew THORNTON, London (GB); Craig GOODING, London (GB); Conor MCGRATH, London (GB); Najeeb YOUNOSSI, London (GB); Kevin YU, London (GB)

(21) Appl. No.: 18/879,652

(22) PCT Filed: Jun. 28, 2023
(86) PCT No.: PCT/EP2023/067711

§ 371 Date: Dec. 27, 2024

(30) Foreign Application Priority Data
Jun. 29, 2022 (GB) 2209546.7
Sep. 1, 2022 (GB) 2212748.4

(51) Int. Cl. A24F 40/50

(52) U.S. Cl. CPC A24F 40/50

(57) ABSTRACT

A method of operating an aerosol provision device, the method including: determining an ambient temperature; comparing the determined ambient temperature with a threshold value; operating the device in a predetermined usage session; setting a limit on the number of back-to-back usage sessions; wherein the limit on the number of back-to-back usage sessions is set in dependence on the comparison between the measured ambient temperature and the threshold value.

### RELATED APPLICATIONS

The present application is a National Phase entry of PCT Application No. PCT/EP2023/067711 filed Jun. 28, 2023, which claims priority to GB Application No. 2209546.7 filed Jun. 29, 2022 and GB Application No. 2212748.4 filed Sep. 1, 2022, each of which is hereby incorporated by reference in their entirety.

### TECHNICAL FIELD

The present invention relates to a method of operating an aerosol provision device. The present invention also relates to an aerosol provision device, and an aerosol provision system comprising an aerosol provision device and an article comprising aerosol generating material.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

In accordance with some embodiments described herein, there is provided a method of operating an aerosol provision device, the method comprising: determining an ambient temperature: comparing the determined ambient temperature with a threshold value; operating the device in a predetermined usage session; setting a limit on the number of back-to-back usage sessions: wherein the limit on the number of back-to-back usage sessions is set in dependence on the comparison between the determined ambient temperature and the threshold value.

The aerosol provision device may comprise a battery, and the ambient temperature may be determined by measuring the temperature of the battery.

The threshold value may be a predetermined temperature value of the battery.

The threshold value may be between 20° C. and 70° C., or between 30° C. and 60° C., or between, 40° C. and 50° C. In embodiments, the threshold value may be 50° C.

The aerosol provision device may comprise a temperature sensor arranged to detect a temperature of the battery.

The temperature sensor may be a thermistor.

The method may comprise setting a first limit on the number of back-to-back usage sessions in dependence on the determined ambient temperature being greater than the threshold value, and setting a second limit on the number of back-to-back usage sessions in dependence on the determined ambient temperature being lower than the threshold value.

The first limit may be lower than the second limit. Alternatively, the first limit may be greater than the second limit.

The first limit may be two back-to-back sessions. Alternatively, the first limit may be three back-to-back sessions.

The second limit may be three back-to-back sessions. Alternatively, the second limit may be two back-to-back sessions.

The threshold value may be a first threshold value and the method may comprise comparing the determined ambient temperature with a second threshold value, and further comprise providing at least one further limit, wherein the limit on the number of back-to-back sessions may be set to the at least one further limit based on the comparison with the second threshold value.

The method may comprise determining the ambient temperature on start-up of the device.

The method may comprise determining when the limit on the number of back-to-back usage sessions has been reached.

The method may comprise providing an indication that the device should not be used when the limit on the number of back-to-back usage sessions has been reached. The indication may be provided by an LED.

The method may comprise preventing the device from being used when the limit on the number of back-to-back usage sessions has been reached.

The method may comprise resetting the back-to-back session count.

The method may comprise identifying when the device enters a charging mode, and resetting the back-to-back session count in response to the device entering a charging mode.

The method may comprise determining how long the device has been in the charging mode, comparing the length of time the device has been in the charging mode to a charging time threshold, and resetting the back-to-back session count only if the length of time is greater than the charging time threshold.

The method may comprise determining the length of time since a usage session has ended, comparing this length of time to a session break threshold, and resetting the back-to-back session count only if the length of time is greater than the session break threshold.

The session break threshold may be 60 seconds, 50 seconds, 40 seconds, 30 seconds, 20 seconds, or 10 seconds.

Operating the device in a predetermined usage session may include at least one of: operating the device for a predetermined length of time: operating the device for a predetermined number of detected puffs taken by a user; detecting insertion of at least a portion of an article comprising aerosol generating material into or onto the device; detecting removal of at least a portion of an article comprising aerosol generating material from the device; detecting insertion of or removal from the device of at least a portion of a first article comprising aerosol generating material; and identification of a user input.

In accordance with some embodiments described herein, there is provided an aerosol provision device comprising: a heating assembly arranged to receive at least a portion of an article containing aerosol generating material: a temperature sensor configured to determine an ambient temperature: a processor; and a memory, wherein the temperature sensor is configured to send the determined temperature to the processor, and wherein the processor is configured to compare the determined ambient temperature to a threshold value, and to set a limit on the number of back-to-back sessions, wherein the limit on the number of back-to-back usage sessions is set in dependence on the comparison between the determined ambient temperature and the threshold value.

In accordance with some embodiments described herein, there is provided a method of operating an aerosol provision device, the method comprising:
prior to the start of an operating session, determining a temperature of the battery as an indication of housing surface temperature;
comparing the determined temperature with a threshold value;
preventing operation of the operating session of the device if the determined temperature exceeds the threshold value.

In accordance with some embodiments described herein, there is provided a computer program comprising instructions which, when the program is executed by a computer, cause the computer to carry out the method described herein.

In accordance with some embodiments described herein, there is provided an aerosol provision system comprising an aerosol provision device as described herein, and an article containing aerosol generating material arranged to be at least partially received by the aerosol provision device.

### BRIEF DESCRIPTION OF THE DRAWINGS

Embodiments of the invention will now be described, by way of example only, with reference to accompanying drawings, in which:

FIG. 1 shows a front view of an aerosol provision device;

FIG. 2 shows a schematic cross-sectional side view of the aerosol provision device of FIG. 1:

FIG. 3 shows a perspective view of an aerosol provision device and case; and

FIG. 4 shows a flow chart illustrating a method of operating an aerosol provision device.

### DETAILED DESCRIPTION

As used herein, the term “aerosol-generating material” is a material that is capable of generating aerosol, for example when heated, irradiated or energized in any other way. Aerosol-generating material may, for example, be in the form of a solid, liquid or gel which may or may not contain an active substance and/or flavorants. Aerosol-generating material may include any plant based material, such as tobacco-containing material and may, for example, include one or more of tobacco, tobacco derivatives, expanded tobacco, reconstituted tobacco or tobacco substitutes. Aerosol-generating material also may include other, non-tobacco, products, which, depending on the product, may or may not contain nicotine. Aerosol-generating material may for example be in the form of a solid, a liquid, a gel, a wax or the like. Aerosol-generating material may for example also be a combination or a blend of materials. Aerosol-generating material may also be known as “smokable material”.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In some embodiments, the aerosol-generating material is substantially tobacco free.

The aerosol-generating material may comprise or be an “amorphous solid”. The amorphous solid may be a “monolithic solid”. In some embodiments, the amorphous solid may be a dried gel. The amorphous solid is a solid material that may retain some fluid, such as liquid, within it. In some embodiments, the aerosol-generating material may, for example, comprise from about 50 wt %, 60 wt % or 70 wt % of amorphous solid, to about 90 wt %, 95 wt % or 100 wt % of amorphous solid.

The aerosol-generating material may comprise an aerosol-generating film. The aerosol-generating film may comprise or be a sheet, which may optionally be shredded to form a shredded sheet. The aerosol-generating sheet or shredded sheet may be substantially tobacco free.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energized so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

An aerosol generating device can receive an article comprising aerosol generating material for heating. An “article” in this context is a component that includes or contains in use the aerosol generating material, which is heated to volatilize the aerosol generating material, and optionally other components in use. A user may insert the article into the aerosol generating device before it is heated to produce an aerosol, which the user subsequently inhales. The article may be, for example, of a predetermined or specific size that is configured to be placed within a heating chamber of the device which is sized to receive the article.

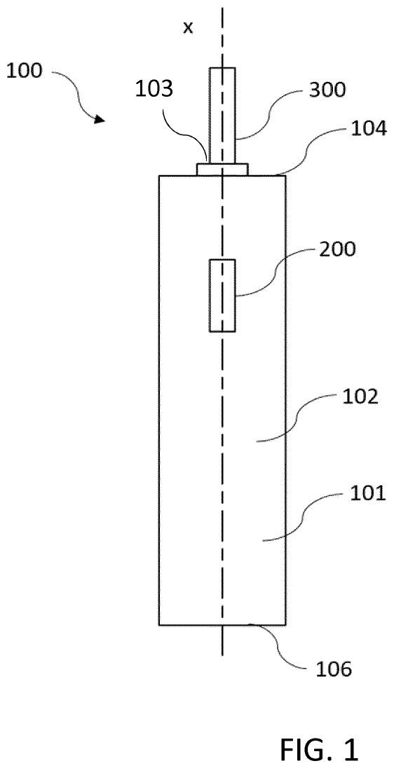

FIG. 1 shows an aerosol provision device 100 for generating aerosol from an aerosol generating material. In broad outline, the device 100 may be used to heat a replaceable article 300 comprising the aerosol generating material, to generate an aerosol or other inhalable medium which is inhaled by a user of the device 100. The article 300 and the device 100 together form an aerosol provision system.

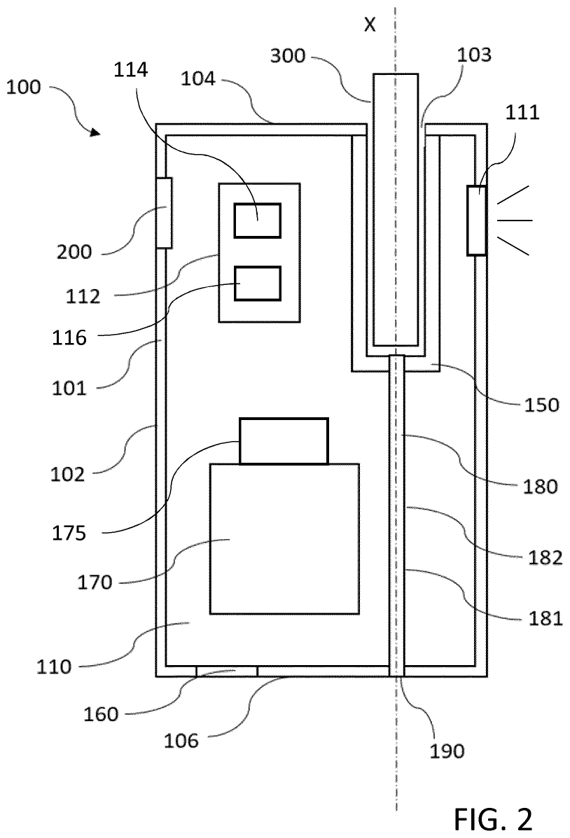

The device 100 comprises a body 101. A housing 102 surrounds and houses various components of the body 101. An opening 103 is formed at one end of the body 101, through which the article 300 may be inserted for heating by an aerosol generator 150 (refer to FIG. 2). In use, the article 300 may be fully or partially inserted into the aerosol generator 150 where it may be heated by one or more components of the aerosol generator 150.

The device 100 also includes a button assembly 200, which operates the device 100 when pressed. For example, a user may turn on the device 100 by operating the button assembly 200.

The aerosol generator 150 defines a longitudinal axis X.

FIG. 2 shows a schematic cross sectional view of the device 100. The device 100 comprises an electrical component, such as a connector/port 160, which can receive a cable to charge a battery of the device 100. For example, the connector 160 may be a charging port, such as a USB charging port. In some examples the connector 160 may be used additionally or alternatively to transfer data between the device 100 and another device, such as a computing device.

The device 100 comprises a power source 170, which in the illustrated embodiment is a battery, such as a rechargeable battery or a non-rechargeable battery. Examples of suitable batteries include, for example, a lithium battery (such as a lithium-ion battery), a nickel battery (such as a nickel-cadmium battery), and an alkaline battery. The battery is electrically coupled to the aerosol generator 150 to supply electrical power when required and under control of a controller to heat the aerosol generating material.

The device comprises a user interface display 111. In the illustrated embodiment, the user interface display 111 is an LED, but in other embodiments, a screen, or other suitable user interface display 11 may be provided.

The body 101 has end surfaces of the device 100. The end of the device 100 closest to the opening 103 may be known as the proximal end (or mouth end) 104 of the device 100 because, in use, it is closest to the mouth of the user. In use, a user inserts an article 300 into the opening 103, operates the aerosol generator 150 to begin heating the aerosol generating material and draws on the aerosol generated in the device. This causes the aerosol to flow through the device 100 along a flow path towards the proximal end of the device 100.

The other end of the device furthest away from the opening 103 may be known as the distal end 106 of the device 100 because, in use, it is the end furthest away from the mouth of the user. As a user draws on the aerosol generated in the device, the aerosol flows in a direction towards the proximal end of the device 100. The terms proximal and distal as applied to features of the device 100 will be described by reference to the relative positioning of such features with respect to each other in a proximal-distal direction along the longitudinal axis.

As used herein, one-piece component refers to a component of the device 100 which is not separable into two or more components following assembly of the device 100. Integrally formed relates to two or more features that are formed into a one-piece component during a manufacturing stage of the component.

An air flow passage 180 extends through the body 101. The airflow passage 180 extends to an air inlet 190.

In one example, the aerosol generator 150 comprises an induction-type heating system, including a magnetic field generator. The magnetic field generator comprises an inductor coil assembly. The aerosol generator 150 comprises a heating element. The heating element is also known as a susceptor.

A susceptor is a material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The device that is configured to generate the varying magnetic field is referred to as a magnetic field generator, herein.

The aerosol generator 150 is an inductive heating assembly and comprises various components to heat the aerosol generating material of the article 300 via an inductive heating process. Induction heating is a process of heating an electrically conducting object (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive heater and the susceptor, allowing for enhanced freedom in construction and application.

The inductor coil assembly includes an inductor coil. In embodiments, the number of inductor coils differs. In embodiments, a two or more inductor coils are used. The inductor coil assembly also comprises a coil support. The coil support is tubular.

The heating element is part of a heating assembly. The heating element of this example is hollow and therefore defines at least part of a receptacle within which aerosol generating material is received. For example, the article 300 can be inserted into the heating element. The heating element is tubular, with a circular cross section. The heating element has a generally constant diameter along its axial length.

In embodiments, the heating assembly defines the receptacle and the heating element upstands in the receptacle.

The heating element is formed from an electrically conducting material suitable for heating by electromagnetic induction. The susceptor in the present example is formed from a carbon steel. It will be understood that other suitable materials may be used, for example a ferromagnetic material such as iron, nickel or cobalt.

In other embodiments, the feature acting as the heating element may not be limited to being inductively heated. The feature, acting as a heating element, may therefore be heatable by electrical resistance. The aerosol generator 150 may therefore comprise electrical contacts for electrical connection with the apparatus for electrically activating the heating element by passing a flow of electrical energy through the heating element. Other forms of heating by the aerosol generator 150 are anticipated.

The receptacle and article 300 are dimensioned so that the article 300 is received by the heating element. This helps ensure that the heating is most efficient. The article 300 of this example comprises aerosol generating material. The aerosol generating material is positioned within the receptacle. The article 300 may also comprise other components such as a filter, wrapping materials and/or a cooling structure.

The air flow passage 180 extends from the receptacle. The air flow passage 180 is at the distal, end. The air flow passage 180 protrudes from the heating element. The air flow passage 180 extending from the heating element is defined by a flow path member 182. The heating element 220 and the flow path member 182 forms part of an airflow path arrangement 181.

The flow path member 182 extends between the heating element and the opening 190. The flow path member 182 is tubular. The flow path member 182 defines a bore. The flow path member extends in an axial direction along its length.

The device 100 comprises an electronics module 112 having at least one controller comprising a processor 114 and a memory 116. The electronics module 112 may comprise, for example, a printed circuit board (PCB). The PCB may support the at least one controller. The PCB may also comprise one or more electrical tracks to electrically connect together various electronic components of the device 100. For example, the battery terminals may be electrically connected to the PCB so that power can be distributed throughout the device 100.

The device 100 comprises a temperature sensor 175. In the illustrated embodiment the temperature sensor 175 is a thermistor. In the illustrated embodiment, the thermistor 175 is mounted on the battery 170 such that the temperature of the battery 170 is measured. The thermistor 175 may be affixed to the battery 170 by any suitable means. For example, the thermistor 175 may be bonded to the battery 170. In embodiments, the battery 170 is affixed using an adhesive. The thermistor 175 may be supported close to or touching the battery 170 by a support structure such as a bracket (not shown).

The thermistor 175 is connected to a temperature calibrated micro-ammeter, as is known, and is electrically connected to the battery 170 in order to provide power to the thermistor—micro-ammeter circuit. This connection may be realised via the PCB. In other embodiments, the thermistor 175 may be powered separately, for example by means of a separate dedicated battery (not shown). The temperature sensor 175 is provided to monitor the temperature of the battery 170 during use of the device 100.

The temperature sensor 175 is electrically connected to the controller such that temperature readings taken by the temperature sensor 175 can be sent to the processor 114.

In embodiments, a temperature sensor is provided on the battery 170 in order to monitor the battery temperature to detect overheating in real-time. In such embodiments therefore, the same temperature sensor 175 can be used both for real-time overheating detection, and for taking the temperature readings required for the method of the present invention. This leads to a reduction in the number of components which may allow the size, weight, and cost of the aerosol provision device 100 to be reduced.

In embodiments, the temperature sensor 175 may not be provided on the battery 170. For example, in embodiments, the temperature sensor 175 may be affixed to an inside surface of the housing 102 such that the surface temperature of the device 100 may be measured.

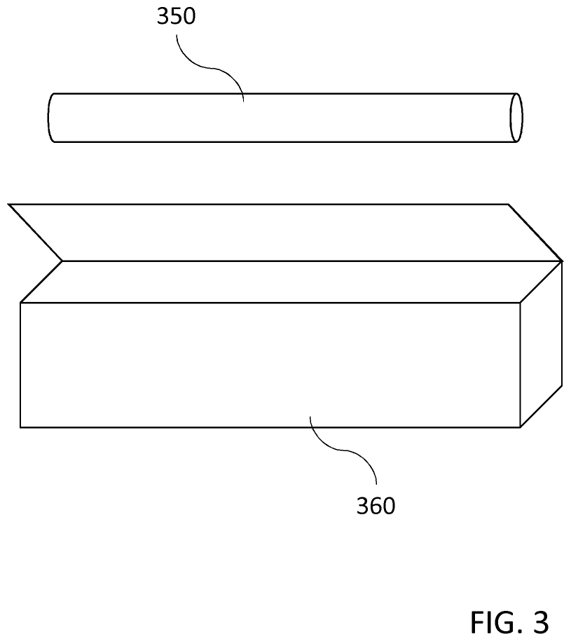

FIG. 3 shows a perspective view of a pen-like aerosol provision device 350 which is removable from a case 360. The case 360 is configured to charge the device 350 when the device is stored inside the case 360. The case 360 may use contact points, or wireless charging as is known.

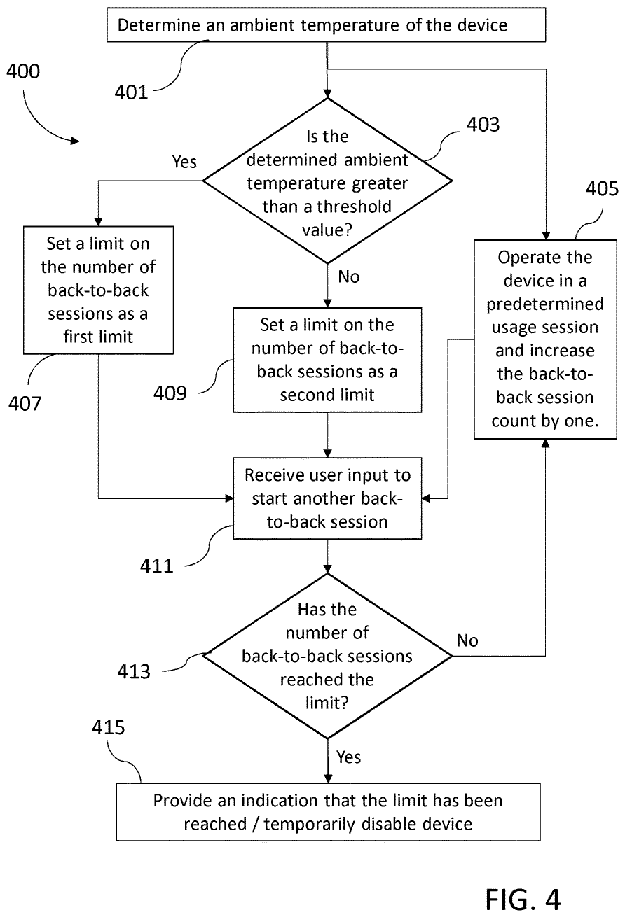

FIG. 4 shows a flow chart illustrating a method 400. At step 401, an ambient temperature of the device 100 is measured. The ambient temperature is determined in dependence on a measured device ambient temperature. The device ambient temperature is indicative of the ambient temperature of the air surrounding the device 100.

In embodiments, the ambient temperature is defined as the temperature of the immediate surroundings around the device 100. The ambient temperature is the air ambient temperature surrounding the device. Upon start-up, the device 100 has not yet started to generate heat, and therefore the temperature of the device 100 is likely to be at or close to the ambient temperature of its surroundings. The temperature of the device is the device ambient temperature. In embodiments, the ambient temperature is defined as the device ambient temperature of the device 100. In embodiments, prior to start-up of the device 100, the device ambient temperature at least substantially corresponds to the air ambient temperature surrounding the device. The ambient temperature of the device 100 may differ from the air ambient temperature surrounding the device. For example, one or more components in the device may generate some thermal energy prior to start-up. Further, thermal radiation, such as sunlight, may heat the device.

As such, in embodiments, the temperature is determined upon start-up of the device 100. In the illustrated embodiment, this comprises measuring the temperature of the battery 170 with the thermistor 175. Before the device 100 has begun a usage session, the temperature of the battery 170 will be indicative of the ambient temperature. The ambient temperature in such embodiments is determined by a temperature of the battery 170. As such, operation of the device may be adjusted based on a determined environmental condition without the need for dedicated components to measure such an environmental condition. In embodiments, determining the ambient temperature may comprise measuring the surface temperature of the device, the external air temperature, or the temperature of an internal component of the device 100. In such embodiments, a temperature sensor having another primary function may be used to determine the ambient temperature, or a separate dedicated ambient temperature sensor may be provided.

After the ambient temperature of the device 100 has been measured at step 401, the device 100 is operated in a predetermined usage session at step 405. Operating the device for a predetermined usage session can be defined in a number of ways. Operating the device 100 for a predetermined usage session may comprise at least one of: operating the device for a predetermined length of time: operating the device for a predetermined number of detected puffs taken by a user; detecting insertion of at least a portion of an article comprising aerosol generating material into or onto the device; detecting removal of at least a portion of an article comprising aerosol generating material from the device: detecting insertion of or removal from the device of at least a portion of a first article comprising aerosol generating material; and identification of a user input. Such predetermined usage sessions are known. The memory 116 keeps a count of how many back-to-back usage sessions have occurred. When a predetermined usage session is begun, the count in the memory 116 is increased by one. At step 403, the measured ambient temperature is sent from the temperature sensor 175 to the processor 114 where it is compared to a threshold value which is stored in the memory 116. In embodiments, the threshold value is set to 40° C. In embodiments, the threshold value is set to 50° C. If the ambient temperature is greater than the threshold value, then the method proceeds to step 407, and the processor 114 sets a limit on the number of back-to-back sessions to a first limit.

In embodiments, the term “back-to-back” when applied to usage sessions is intended to mean that the period of time which has passed between the end of one usage session, and the start of a subsequent usage session is below a predetermined value (a session break threshold). In embodiments, the predetermined time period is equal to 30 seconds. It will be understood by the skilled person that by setting a limit for the number of such of back-to-back sessions based on the measured ambient temperature, the likelihood of the device overheating can be reduced whilst still allowing users to perform back-to-back sessions if the risk is low. For example, where the device has a low ambient temperature which could result from the user being outside on a cold day, the device may be able to perform a greater number of back-to-back sessions before overheating. By setting the limit based on the measured ambient temperature, this extra functionality can be realised.

In such embodiments, the first limit may be lower than the second limit.

In other embodiments, the term “back-to-back”, when applied to usage sessions is intended to mean that the sessions have been performed in the same usage period between two charging periods. It will be understood by the skilled person that by setting a limit for the number of such back-to-back sessions based on the determined ambient temperature, the likelihood of the device's battery running out during a session is reduced since the effect of ambient temperature on battery performance is taken into account. The user is therefore provided with a better experience. For example, where the device has a low ambient temperature which could result from the user being outside on a cold day, the battery in a device may be able to perform a lower number of back-to-back sessions before requiring re-charging since batteries under-perform in low temperatures. By setting the limit based on the determined ambient temperature, this temperature effect can be taken into account and adjusted for.

In such embodiments, the first limit may be greater than the second limit.

In embodiments, the first limit is two back-to-back sessions. If the ambient temperature is not greater than the threshold value, then the method proceeds to step 409, and the processor sets a limit on the number of back-to-back sessions to a second limit. In embodiments, the second limit is three back-to-back sessions. In the illustrated embodiment, if the measured ambient temperature is equal to the threshold value, then the limit is set to the second limit. In embodiments however, the limit could be set to the first limit when the measured ambient temperature is equal to the threshold value.

Once the predetermined usage session of step 405 has ended, a user may request that another session is started before re-charging the device 100/before the session break threshold has passed (a back-to-back session). At step 411 therefore, a user input to start another back-to-back session is received. This input may be received in any suitable manner, but in the illustrated embodiment, the input is received via the button assembly 200, and communicated to the processor 114. Upon receiving this input, at step 413, the processor 114 retrieves the back-to-back session count from the memory 116 and determines whether the back-to-back session count has reached the set limit. If the limit has been reached, the method proceeds to step 415. At step 415, an indication may be provided to the user indicating that the back-to-back session limit has been reached. In the illustrated embodiment, the indication is given by the LED 111. For example, the indication may comprise the LED flashing. In other embodiments, the indication may be given via any suitable display means, such as readout on a screen.

Additionally, or alternatively, at step 415, the device may be temporarily disabled in order to prevent a user from starting another back-to-back session in spite of the notification that the limit has been reached. The device may be disabled in any suitable way. For example, the power to the aerosol generator 150 may be cut off for a fixed period of time, or the power to the button assembly 200 may be cut off for a fixed period of time to prevent user inputs requesting further sessions from being registered.

If the limit has not been reached, the method returns to step 405, and allows a further predetermined usage session to begin.

In embodiments, the threshold value of step 403 is a first threshold, and the method comprises a further step (not shown) of comparing the measured ambient temperature to a second threshold value in response to the comparison to the first threshold. For example, the second threshold may be greater than the first threshold. Therefore, if the measured ambient temperature is lower than the first threshold, the limit is set to the first limit, if the measured ambient temperature is greater than the first threshold, then it is compared to the second threshold. If the measured ambient temperature is greater than the first threshold but lower than the second threshold then the limit is set to the second limit, if the measured ambient temperature is greater than the second threshold, then the limit is set to a third limit. The third limit may be equal to one. In alternative embodiments, the second threshold may be lower than the first threshold. In embodiments, a plurality of thresholds may be provided which are lower and greater than the first threshold such that the limit can be more specifically tailored to the measured ambient temperature.

After a period of time equal to the session break threshold has elapsed, the back-to-back session count is reset to zero. In embodiments where back-to-back sessions are defined as sessions occurring within the same usage period, the back-to-back session count is reset to zero when the device has been recharged.

In embodiments, the method comprises determining when the device 100 enters a charging mode. This may be achieved by monitoring a current through a charging port of the device. In embodiments, the back-to-back session count is reset to zero in response to the device 100 entering the charging mode. However, in other embodiments, the method may comprise determining how long the device 100 has been in the charging mode, comparing the length of time the device 100 has been in the charging mode to a charging time threshold, and resetting the back-to-back session count only if the length of time is greater than the charging time threshold. In other embodiments, determining whether the charge level is sufficiently high may comprise comparing the charge level to a charge level threshold, and resetting the back-to-back session count if the charge level is above the charge level threshold. In embodiments, the charge level threshold is set to one of 50%, 60%, 80%, 90% or 100%

After the back-to-back session count is reset to zero, when the device 100 is next started up, the method restarts from step 401. In embodiments, the charge level threshold is set to one of 50%, 60%, 80%, 90% or 100%.

In embodiments, both the charge level and the ambient temperature may be taken into account when setting the back-to-back session limit.

Embodiments of the invention where back-to-back sessions are defined as sessions occurring in the same usage period may be particularly applicable for pen-like aerosol provision devices which are frequently stored in a charging carry case. The device is removed from the case by a user in order to use the device.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. A method of operating an aerosol provision device, the method comprising:
determining an ambient temperature;
comparing the determined ambient temperature with a threshold value;
operating the device in a predetermined usage session;
setting a limit on the number of back-to-back usage sessions;
wherein the limit on the number of back-to-back usage sessions is set in dependence on the comparison between the measured ambient temperature and the threshold value.

2. The method of claim 1, wherein aerosol provision device comprises a battery, and wherein the ambient temperature is determined by measuring the temperature of the battery.

3. The method of claim 2, wherein the threshold value is a predetermined temperature value of the battery.

4. The method of claim 2, wherein the aerosol provision device comprises a temperature sensor arranged to detect a temperature of the battery.

5. The method of claim 1, wherein the method comprises setting a first limit on the number of back-to-back usage sessions in dependence on the determined ambient temperature being lower than the threshold value, and setting a second limit on the number of back-to-back usage sessions in dependence on the determined ambient temperature being higher than the threshold value.

6. The method of claim 5, wherein the first limit is two back-to-back sessions.

7. The method of claim 5, wherein the second limit is three back-to-back sessions.

8. The method of claim 5, wherein the threshold value is a first threshold value and the method comprises comparing the measured ambient temperature with a second threshold value, and comprises providing at least one further limit, wherein the limit on the number of back-to-back sessions is set to the at least one further limit based on the comparison with the second threshold value.

9. The method of claim 1, comprising determining the ambient temperature on start-up of the device.

10. The method of claim 1, comprising determining when the limit on the number of back-to-back usage sessions has been reached.

11. The method of claim 10, comprising providing an indication that the device should not be used when the limit on the number of back-to-back usage sessions has been reached.

12. The method of claim 10, comprising preventing the device from being used when the limit on the number of back-to-back usage sessions has been reached.

13. The method of claim 1, comprising resetting the back-to-back session limit.

14. The method of claim 1, wherein operating the device in a predetermined usage session, includes at least one of: operating the device for a predetermined length of time; operating the device for a predetermined number of detected puffs taken by a user; detecting insertion of at least a portion of an article comprising aerosol generating material into or onto the device; detecting removal of at least a portion of an article comprising aerosol generating material from the device; detecting insertion of or removal from the device of at least a portion of a first article comprising aerosol generating material; and
identification of a user input.

15. An aerosol provision device comprising:
a heating assembly arranged to receive at least a portion of an article containing aerosol generating material;
a temperature sensor configured to detect a temperature;
a processor; and
a memory,
wherein the temperature sensor is configured to send the detected temperature to the processor, and wherein the processor is configured to compare the detected temperature to a threshold value, and to set a limit on the number of back-to-back sessions, wherein the limit on the number of back-to-back usage sessions is set in dependence on the comparison between the detected temperature and the threshold value.

16. A computer program comprising instructions which, when the program is executed by a computer, cause the computer to carry out the method of claim 1.

17. (canceled)
